(19) United States
(12) Patent Application Publication
(10) Pub. No.: US 2020/0181942 A1
(43) Pub. Date: Jun. 11, 2020

(54) GALLEY LOCK

(71) Applicant: Airbus Operations GmbH, Hamburg (DE)

(72) Inventors: Michael Bauer, Hamburg (DE); Falk Bajorat, Hamburg (DE)

(73) Assignee: Airbus Operations GmbH, Hamburg (DE)

(21) Appl. No.: 16/701,813

(22) Filed: Dec. 3, 2019

(30) Foreign Application Priority Data
Dec. 7, 2018 (DE) 10 2018 131 429.9

(51) Int. Cl. E05B 41/00; E05B 73/00; B64D 11/04; B64D 11/00

(52) U.S. Cl. CPC E05B 41/00; B64D 11/0007; B64D 11/04; E05B 73/00

(57) ABSTRACT

To make available monitoring of the lock in a way which permits a variable configuration of the galley design and ensures reliable checking without limiting the sequencing and operation, an aircraft galley module lock-monitoring device includes a multiplicity of locking elements, a multiplicity of sensors and a signal-processing unit. The locking elements are designed to be moved from a release position into a locking position. The locking elements are designed to secure, in the locking position, a galley insert in a receptacle region, and to release the galley insert in the release position. The galley insert may include aircraft trolleys and standard units. The sensors are designed to sense at least the locking positions of the locking elements and to transmit a locking signal to the signal-processing unit. The signal-processing unit is designed to generate a lock status display on the basis of the locking signals.

### FIELD OF THE INVENTION

The present invention is concerned with locks in galleys of aircraft and relates, in particular, to a lock-monitoring device for a galley module of an aircraft, to a galley module for an aircraft and to a method for monitoring a lock state for a galley module of an aircraft.

### BACKGROUND OF THE INVENTION

In aircraft, for example passenger aircraft, galleys are provided in order to be able to supply passengers with meals and drinks onboard. The galleys are used for storage, preparation and disposal purposes during the flight. For example trolleys are accommodated in the galleys and are to a certain extent moved onboard in the passenger cabin area during the flight, for example in order to serve the meals and drinks. Furthermore, trolleys and standard units are used to bring meals and drinks onboard and to accommodate and store them there, or also to collect and dispose of waste. For the temporary accommodation of the trolleys and standard units, receptacle regions in which the trolleys can be parked are provided in galleys. For the sake of safe stowage, for example when starting and landing, locks are provided with which the trolleys are secured in the parked position. The locks have to be monitored or checked during specific flight phases or specific flight situations in order to ensure that the trolleys are reliably secured. The monitoring is carried out, for example, by means of visual inspection by the cabin personnel. However, this is costly and laborious and is also susceptible to errors. For example, monitoring of the locks with a camera is provided for the purpose of checking in EP 2 845 801 A1. However, it has become apparent that this can cause limitations in the design of galleys or else operational limitations.

### BRIEF SUMMARY OF THE INVENTION

Aspects of the present invention may make available monitoring of the lock in a way which permits the most variable possible configuration of the galley design and in addition ensures reliable checking without limiting the sequencing and the operation.

It is to be noted that the following described aspects apply to the lock-monitoring device, to the galley module and to the method.

According to an embodiment of the invention, a lock-monitoring device is provided for a galley module of an aircraft. The lock-monitoring device has a multiplicity of locking elements, a multiplicity of sensors and a signal-processing unit. The locking elements are designed to be moved, in the mounted state, from a release position into a locking position. The locking elements are designed to secure, in the locking position, a galley insert in a receptacle region, and to release the galley insert in the release position. The galley insert is selected from the group at least comprising aircraft trolleys and standard units. The sensors are designed to sense at least the locking positions of the locking elements and to transmit a locking signal to the signal-processing unit. The signal-processing unit is designed to generate a lock status display on the basis of the locking signals.

This ensures reliable monitoring. The configuration of the galley is therefore limited just as little as the operations onboard the aircraft.

The term “galley module” relates to individual modules of a galley, e.g. a wall-shaped arrangement of storage compartments and devices for storing, preparing and disposing of meals and drinks onboard an aircraft, e.g. passenger aircraft. The term “galley module” relates also to an entire galley.

The term “galley insert” relates to inserts in galleys which are used in provided structures. For example, containers or components are at least partially introduced into compartments, openings and receptacles and at least temporarily secured or attached there to the structure. The introduction can occur, for example, as insertion, sliding in, suspension, rolling in or moving in. The galley insert is, for example, an aircraft trolley or a standard unit. The galley insert is embodied in a further example as an equipment insert which is not permanently provided but rather has to be exchanged or serviced regularly for example.

The term “aircraft trolley” comprises movable transportation aids which have wheels or rollers and can be moved onboard an aircraft. The transportation aids are embodied, for example, as storage containers for supplying the passengers with drinks and food and also for disposal purposes. Instead of the term “aircraft trolley” it is also possible to use the terms “aircraft roller containers”, “aircraft serving container trolleys” or “aircraft serving trolleys”. The aircraft trolleys can also be referred to as onboard trolleys.

The term standard unit (SU) relates to movable containers which are usually embodied without rollers. The standard units serve, for example, for transportation (delivery and disposal) and for storing meals and drinks as well as also various objects which are required to prepare and consume meals and drinks onboard aircraft. The standard units can also be referred to as galley inserts (GAINS). For example, the standard units can be slid into the receptacles. The standard units can therefore also be referred to as galley slide-in units.

The term aircraft relates to aeroplanes and also helicopters. For example the term denotes passenger aircraft.

The term “receptacle regions” denotes, for example, storage compartments or free fields, or volumes into which a component can be inserted, in order to be accommodated at least partially in the receptacle region.

The term locking element denotes components which can be attached in a movable fashion and which aircraft trolleys or standard units can be secured.

The term sensor denotes components which can sense a specific state and generate a signal.

The term signal-processing unit denotes a component or a part with which the individual signals can be sensed, in order to generate a display in accordance with the signals. The signal-processing unit can also be referred to as a control unit or monitoring unit or processing unit.

The transmission of the locking signal to the signal-processing unit can occur, for example, in a wire-bound or wireless fashion.

In the locking position, the locking elements are designed to project into an access opening in the receptacle region in order to prevent an aircraft trolley (or a standard unit) located in the receptacle region from leaving said receptacle region, in that the locking elements engage in the movement area and block it. The locking elements are also designed to release the access opening of the receptacle region in the locking position, i.e. no longer to block the aircraft trolley (or the standard unit).

The lock-monitoring device can also be referred to as a lock-sensing device.

The lock status display permits simple monitoring of the locking of the receptacle regions. The lock status display can display, for example, unambiguous information indicating that all of the receptacle regions are locked. This prevents incorrect locking being overlooked.

In one example there is provision that the lock status display indicates where a receptacle region is not correctly locked.

According to one example, a display apparatus is provided on which the lock status display can be displayed.

In one example, the lock status display can be displayed on a separate monitor.

The separate monitor is arranged, for example, in such a way that it can be seen and viewed from a flight attendant's seat. This ensures that the monitoring can occur even during flight phases when the flight attendants have to have taken their seats, for example when starting and landing or when turbulence occurs. The monitor can also be viewed from other locations or positions.

In one example, the monitor is a movable display apparatus, for example a portable display (English: tablet). In another example, the monitor is a movably attached display apparatus.

In another example, the lock status display can be displayed on a flight attendant monitor which is already provided for other purposes.

According to one example, at least some of the locking elements are embodied with a drive with which the locking elements can be moved at least from the release position into the locking position.

The drive is connected, for example, to the signal-processing unit. In one example, the actuation occurs jointly. In another example, the locking elements can be actuated separately.

In one example, the locking elements can be moved with the drive from the locking position into the release position.

For example, locking elements can be operated automatically or with remote control.

According to one example, the drive can be integrated into a horizontal or vertical partition or subdivision of the galley structure.

The term “galley” denotes a kitchen onboard an aircraft. The term galley structure denotes the supporting structure of a galley.

According to one example, the drive is equipped with an encoder which senses the movement of the drive. The encoder is designed to transmit a movement signal as a locking signal to the signal-processing unit. The signal-processing unit is designed to derive the locking position of the locking element from the sensing by the encoder.

The encoder is embodied in this example as the sensor.

According to one example, the locking elements are embodied as pivotable locking levers.

The sensors each sense a relative position of the locking lever with respect to a base.

According to one example, the sensors are embodied as a sensor composed of the group of Hall sensors, limit switches, stop switches and capacitive sensors.

According to one example, the locking levers can be moved manually and an energy-generating device is provided which generates and makes available electrical energy during the movement of the locking lever, which electrical energy can be stored in an accumulator, wherein the stored energy is provided for generating the locking signal.

For example, the transmission of the locking signal occurs by radio so that an autonomous monitoring apparatus is possible.

According to an embodiment of the invention, a galley module for an aircraft is also provided. The galley module has a supporting structure and a lock-monitoring device according to one of the preceding examples. The supporting structure has a multiplicity of receptacle regions, for receiving at least one galley insert selected from a group at least comprising aircraft trolleys and standard units. The locking elements are movably attached to the supporting structure.

The supporting structure has, for example, a multiplicity of walls between which the receptacle regions are formed.

The supporting structure of the galley can also be referred to as a galley structure.

In one example, two locking elements, of which at least one locking element is embodied with a sensor, are provided per receptacle region and aircraft trolley.

In one example, an aircraft trolley (or a standard unit) is accommodated temporarily at least in one part of the receptacle regions.

According to an example, a lock state is sensed continuously with the sensors and the signal-processing unit.

In one example, only one of the locking elements is embodied with a sensor. In another example, both locking elements are respectively embodied with a sensor.

In one example, two locking levers are provided per receptacle region. The locking levers are embodied in two different lengths. One length is provided to sense an upper frame of an aircraft trolley, wherein the door of the aircraft trolley is freely movable. The other length is provided for sensing the upper frame of the aircraft trolley and the door.

According to one example, at least some of the receptacle regions have a receptacle depth, so that two or more aircraft trolleys (or standard units) can be accommodated one behind the other. Intermediate bolts are additionally provided for securing an aircraft trolley (standard unit) which is located in the deeper region. Furthermore, sensors are provided with which a state of the intermediate bolts can be sensed.

According to one example, a flight attendant monitor is provided and the lock status display can be displayed on an additional, separate monitor.

The flight attendant monitor is also referred to as a flight attendant panel (FAP). The flight attendant monitor serves to display cabin-related information for flight attendants.

In other examples, other monitors are provided on which the lock status display can be displayed.

In one example, the lock status display can be displayed on a flight attendant panel.

According to an aspect of the invention, a method for monitoring a lock state for a galley module of an aircraft is also provided. The method has the following steps:

a) sensing of locking positions of locking elements which are designed to be moved, in the mounted state, from a locking position into a release position; wherein in the locking position the locking elements secure a galley insert, selected from the group at least comprising aircraft trolleys and standard units, in a receptacle region, and in the release position they release the galley insert;

b) transmitting a locking signal to a signal-processing unit; and

c) generating a lock status display on the basis of the locking signals.

According to one aspect of the invention there is provision that the locking elements in a galley are provided with sensors in order to sense their position on the locks. The signals of the sensors are sensed and a corresponding display is generated, which can then be monitored.

It is to be noted that the features of the exemplary embodiments of the system also apply to embodiments of the cabin segment and to the vehicle, and vice versa. Furthermore, those features with respect to which this is not explicitly mentioned can also be freely combined with one another.

These aspects and further aspects of the invention become apparent with reference to the following embodiments.

### BRIEF DESCRIPTION OF THE DRAWINGS

More details will be given on exemplary embodiments of the invention below with reference to the appended drawings, in which:

FIG. 1 shows a schematic illustration of an example of a lock-monitoring device;

FIG. 2 shows an example of a galley module in a view;

FIG. 3 shows an example of a locking element with a sensor for generating a signal;

FIG. 4 shows a further example of a locking element with an energy-generating device;

FIG. 5 shows an example of a locking element with a drive;

FIG. 6 shows an example of a locking element with an encoder for generating a signal;

FIG. 7 shows an aircraft with an example of a galley module; and

FIG. 8 shows an example of a method for monitoring a lock state for a galley module of an aircraft.

### DETAILED DESCRIPTION

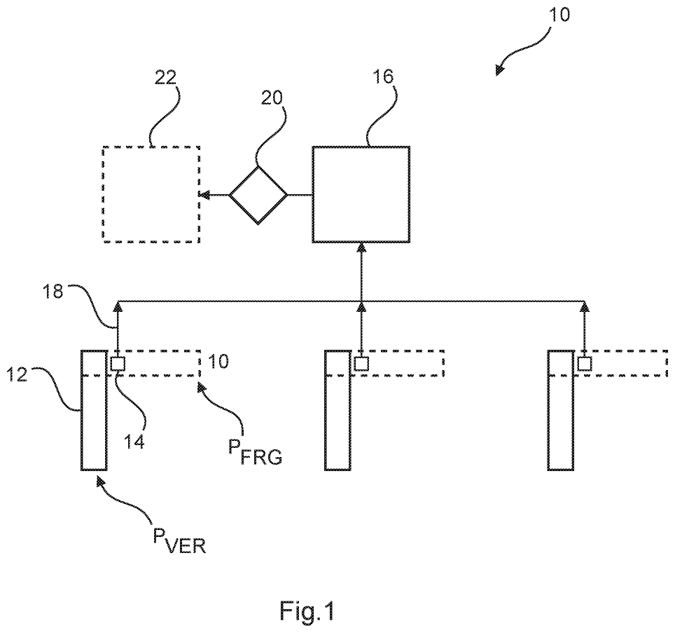

FIG. 1 shows a schematic view of an example of a lock-monitoring device 10 for a galley module of an aircraft. The lock-monitoring device 10 has a multiplicity of locking elements 12, a multiplicity of sensors 14 and a signal-processing unit 16. For the sake of a clearer overview, three locking elements 12 and three sensors 14 are shown in FIG. 1. However, more than three locking elements 12 and three sensors 14 may also be provided.

The locking elements 12 can be moved, in a mounted state from a locking position P_{VER} into a release position P_{FRG} and vice versa. The locking elements 12 are also designed to secure, in the locking position P_{VER}, a galley insert selected from the group at least comprising an aircraft trolley and a standard unit in a receptacle region, and to release the galley insert in the release position P_{FRG}, e.g. the aircraft trolley or the standard unit.

The sensors 14 are designed to sense at least the locking positions P_{VER} of the locking elements 12 and to transmit a locking signal 18 to the signal-processing unit 16.

The signal-processing unit 16 is designed to generate a lock status display 20 on the basis of the locking signals 18.

As an option, a display apparatus 22 is provided on which the lock status display 20 can be displayed.

The locking elements 12 are embodied, for example, as pivotable locking levers. The sensors 14 each sense a relative position of the locking lever with respect to a base. Continuous sensing of a lock state can be carried out with the sensors 14 and the signal-processing unit 16.

The sensors 14 are embodied as a sensor composed of the group of Hall sensors, limit switches, stop switches and capacitive sensors.

The various aspects are described below with respect to aircraft trolleys, this also includes the corresponding variants in relation to standard units.

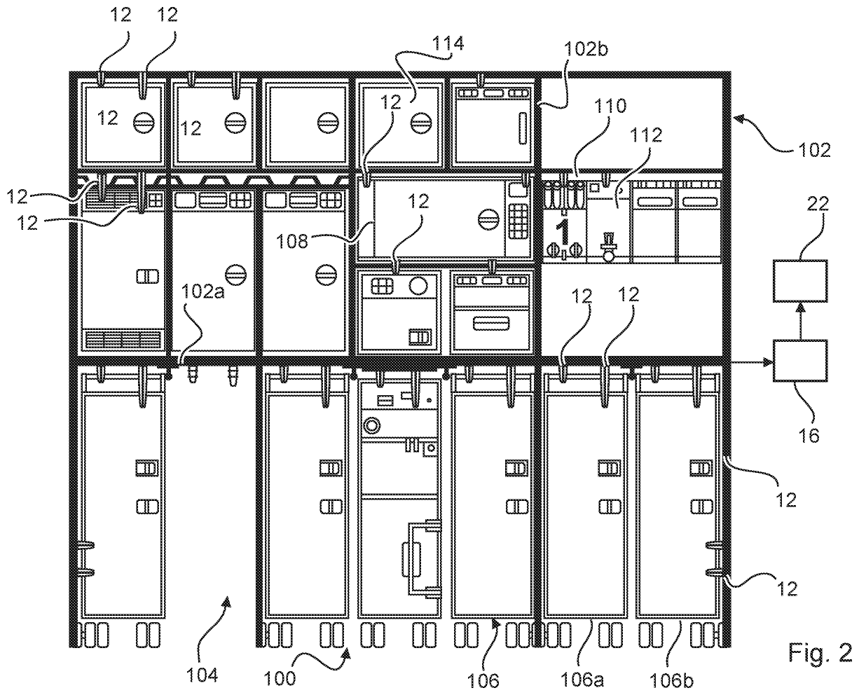

FIG. 2 shows an example of a galley module 100 for an aircraft. The galley module has a supporting structure 102 and the lock-monitoring device 10 according to one of the preceding and following examples. The supporting structure has a multiplicity of receptacle regions 104, for accommodating at least one galley insert selected from a group at least comprising aircraft trolleys 106 and standard units. For example, full-size trolleys 106a and half-size trolleys 106b can be provided. The locking elements 12 are attached in movable fashion to the supporting structure 102. The supporting structure 102 has, for example, shelf-like horizontal subdivisions or bases 102a and vertical sidewalls 102b. The locking elements 12 are embodied, for example, as short and long bolts, wherein each trolley is assigned a short bolt and a long bolt.

For example, the trolleys 106 are accommodated in the lower region in the galley module 100. The trolleys 106a, 106b are secured in a releasable fashion by the locking elements 12. The correct securement of the trolleys 106a, 106b can be monitored with the sensors 14 of the locking elements 12.

In the galley module 100, for example various technical installations, such as for example an oven or a microwave 108, a coffee machine 110 or a small beer tap 112, are provided in the upper region. Furthermore, standard units 114 can also be accommodated.

The technical installations can be installed with fixed connections (not shown in more detail) or with locks, which, however, remain locked during the flight or are unlocked only in exceptional cases. The technical installations can, for example, also be locked to the locking elements 12, and the correct securement of the technical installations can be monitored with the sensors 14. In FIG. 12 this is shown at two locations. It is to be noted that the use of the locking elements 12 for the technical installations is an option. In one example, the technical installations are locked to the locking elements 12. In another example, only some of the technical installations are locked to the locking elements 12.

The standard units 114 are secured, for example, at least partially also with the locking elements 12 (shown partially in FIG. 2) in the corresponding receptacles of the supporting structure. The correct installation and the correct locking of the standard units 114 can be monitored with the sensors 14 (likewise not shown). In FIG. 12 this is shown as two locations. It is to be noted that the use of the locking elements 12 for the standard units 114 is an option. In one example, all the standard units 114 are locked to the locking elements 12. In another example, only some of the standard elements 114 are locked to the locking elements 12.

In one example, at least some of the receptacle regions 104 have a receptacle depth, so that two or more of the aircraft trolleys 106 can be accommodated one behind the other. In order to secure an aircraft trolley which is located in the deeper region, intermediate bolts (not shown) are additionally provided. Furthermore, sensors are provided with which a state of the intermediate bolts can be sensed.

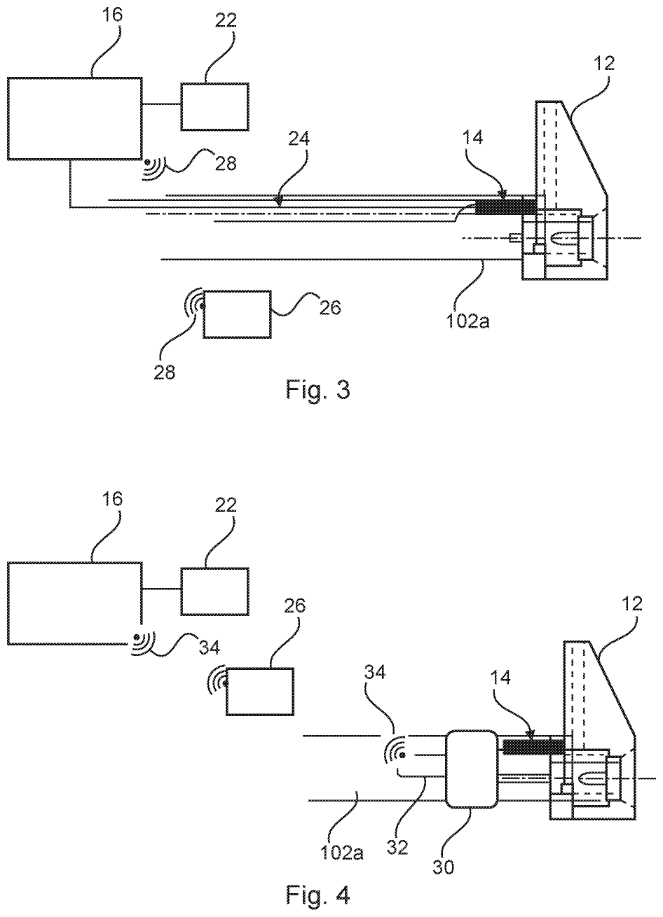

FIG. 3 shows a schematic section through a horizontal subdivision or base 102a. On the right, the locking element 12 is shown in an upwardly pivoted state. To the left of this, the sensor 14 is illustrated. The sensor 14 is connected to the signal-processing unit with a cable, for example. In another example, a wireless connection is provided. The signal-processing unit 16 is connected to the display apparatus 22, for example in a wire-bound or wireless fashion. Furthermore, it is shown as an option that a further display 26 is provided which is connected, for example, in a wireless fashion 28 to the signal-processing unit 16.

FIG. 4 shows as an option that the locking element 12 is embodied as a manually movable locking lever, and an energy-generating device 30 is provided which, when the locking lever moves, generates and makes available electrical energy. The electrical energy can be stored in an accumulator (not shown). The stored energy is provided for generating the locking signal. An electronic module for making available, for example, wireless transmission 34 of the signal is shown schematically in FIG. 4.

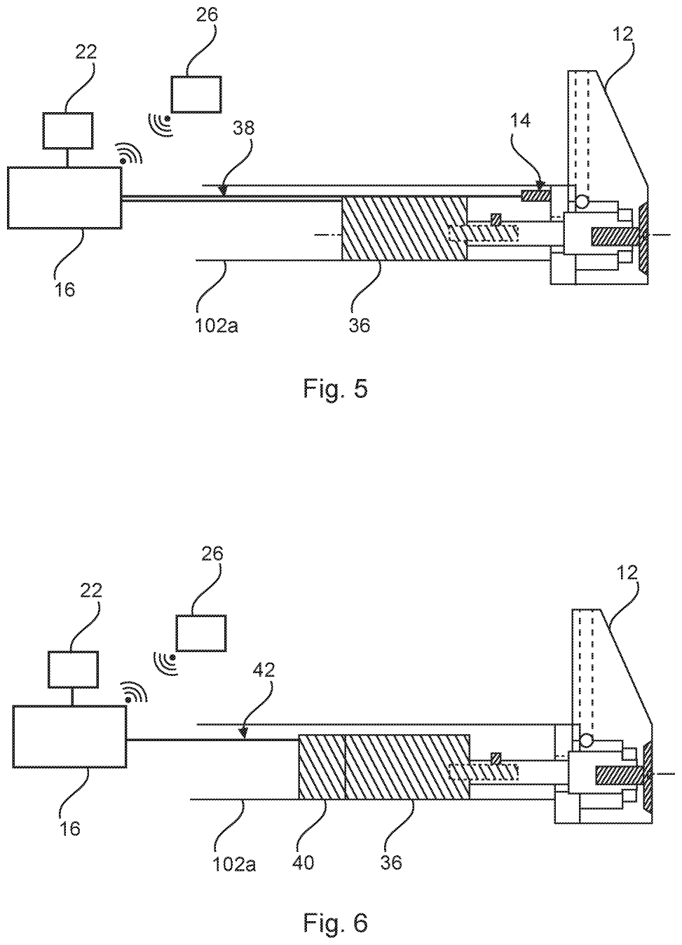

FIG. 5 shows as an option that the locking element 12 is equipped with a drive 36. The drive 36, for example an electric motor, is connected by a cabling 38 to the signal-processing unit 16, which is provided as a control unit for the drive. In one variant, a separate control unit is provided for the drive 36. For example, at least some of the locking elements 12 are embodied with the drive 36, with which the locking elements 12 can be moved at least from the release position P_{FRG} into the locking position P_{VER}.

The drive 36 can be integrated into a horizontal or vertical partition or subdivision of the galley structure, i.e. of the supporting structure.

FIG. 6 shows as a further option that an encoder 40 for generating a signal, i.e. the locking signal, is connected to the drive 36. The encoder 40 senses the movement of the drive 36 and is designed to transmit a movement signal as a locking signal to the signal-processing unit 16. For this purpose, for example a cabling 42 is provided. Alternatively or additionally, a wireless connection can be provided. The signal-processing unit 16 is designed to derive the locking position of the locking element 12 from the sensing by the encoder 40.

In an example which is not shown in detail a flight attendant monitor is provided. The lock status display is displayed on an additional, separate monitor.

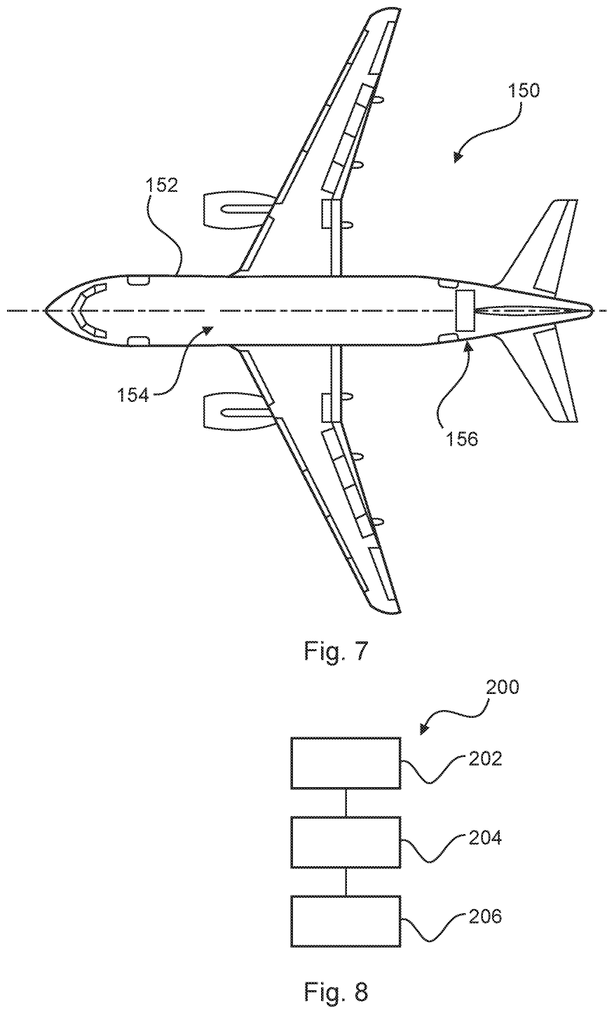

FIG. 7 shows an example of an aircraft 150 with a fuselage structure 152 in which a cabin region 154 is provided. At least one galley module 156 is arranged in the cabin region 154, for example in the rear region.

FIG. 8 shows an example of a method 200 for monitoring a lock state for a galley module of an aircraft. The method 200 has the following steps:

In a first step 202, also referred to as step a), locking positions of locking elements are sensed which are designed to move in a mounted state, from a locking position into a release position. The locking elements secure, in the locking position, a galley insert selected from the group at least comprising aircraft trolleys and standard units in a receptacle region, and release the galley insert in the release position,
in a second step 204, also referred to as step b), a locking signal is transmitted to a signal-processing unit,
in a third step 206, also referred to as step c), a lock status display is generated on the basis of the locking signals.

The exemplary embodiments described above can be combined in different ways. In particular, aspects of the method can also be used for embodiments of the devices and the use of the devices, and vice versa.

In addition it is to be noted that “comprising” does not exclude any other elements or steps and “a” does not exclude a plurality. In addition, it is to be noted that features or steps which have been described with reference to one of the above exemplary embodiments can also be used in combination with other features or steps of other exemplary embodiments described above. Reference symbols in the claims are not to be considered as limiting.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A lock-monitoring device for a galley module of an aircraft, comprising:
a multiplicity of locking elements;
a multiplicity of sensors; and
a signal-processing unit;
wherein the locking elements are configured to be moved, in a mounted state, from a release position into a locking position; and wherein the locking elements are configured to secure, in the locking position, at least one galley insert in a receptacle region and to release the galley insert in the release position, wherein galley insert is selected from the group consisting of aircraft trolleys and standard units;
wherein the sensors are configured to sense at least the locking positions of the locking elements and to transmit a locking signal to the signal-processing unit; and
wherein the signal-processing unit is configured to generate a lock status display on the basis of the locking signals.

2. The lock-monitoring device according to claim 1, further comprising a display apparatus configured to display the lock status display.

3. The lock-monitoring device according to claim 1, wherein at least some of the locking elements are embodied with a drive configured to move the locking elements at least from the release position into the locking position.

4. The lock-monitoring device according to claim 1, wherein the drive is configured to be integrated into a horizontal or vertical partition or subdivision of a galley structure.

5. The lock-monitoring device according to claim 1, wherein the drive is equipped with an encoder configured to sense the movement of the drive;
wherein the encoder is configured to transmit a movement signal as a locking signal to the signal-processing unit; and
wherein the signal-processing unit is configured to derive the locking position of the locking element from the sensing by the encoder.

6. The lock-monitoring device according to claim 1, wherein the locking elements are configured as pivotable locking levers; and
wherein the sensors each is configured to sense a relative position of the locking lever with respect to a base.

7. The lock-monitoring device according to claim 1, wherein the sensors are embodied as a sensor selected from the group consisting of Hall sensors, limit switches, stop switches and capacitive sensors.

8. The lock-monitoring device according to claim 1, wherein the locking lever is configured to be moved manually, and an energy-generating device is provided which generates and makes available electrical energy during the movement of the locking lever, which electrical energy can be stored in an accumulator, wherein the stored energy is provided for generating the locking signal.

9. A galley module for an aircraft, comprising:
a supporting structure; and
a lock-monitoring device according to claim 1;
wherein the supporting structure has a multiplicity of receptacle regions for receiving at least one galley insert selected from a group consisting of aircraft trolleys and standard units;
wherein the locking elements are movably attached to the supporting structure.

10. The galley module according to claim 9, wherein the sensors and the signal-processing unit are configured to sense a lock state continously.

11. The galley module according to claim 9, wherein at least some of the receptacle regions have a receptacle depth so that two or more aircraft trolleys can be accommodated one behind the other; and
wherein intermediate bolts are additionally provided for securing an aircraft trolley which is located in the deeper region;
the galley module further comprises sensors configured to sense a state of the intermediate bolts.

12. The galley module according to claim 9, further comprising a flight attendant monitor; and
wherein the lock status display is configured to be displayed on an additional separate monitor.

13. A method for monitoring a lock state for a galley module of an aircraft, wherein the method comprises:
a) sensing of locking positions of locking elements configured to be moved, in a mounted state, from a locking position into a release position; wherein in the locking position the locking elements secure a galley insert, selected from the group consisting of aircraft trolleys and standard units, in a receptacle region, and in the release position the locking elements release the galley insert;
b) transmitting a locking signal to a signal-processing unit; and
c) generating a lock status display on the basis of the locking signals.

14. A computer-readable medium on which a program element for controlling an apparatus according to claim 1 is stored, which, when executed by a processor unit, is configured to execute a method comprising:
a) sensing of locking positions of locking elements configured to be moved, in a mounted state, from a locking position into a release position; wherein in the locking position the locking elements secure a galley insert, selected from the group consisting of aircraft trolleys and standard units, in a receptacle region, and in the release position the locking elements release the galley insert;
b) transmitting a locking signal to a signal-processing unit; and
c) generating a lock status display on the basis of the locking signals.
